(19) United States
(12) Patent Application Publication
(10) Pub. No.: US 2024/0426364 A1
(43) Pub. Date: Dec. 26, 2024

(54) CYLINDER DEVICE

(71) Applicant: HITACHI ASTEMO, LTD., Ibaraki (JP)

(72) Inventors: Rinnosuke ODA, Hitachinaka-shi (JP); Hiroaki TACHIBANA, Hitachinaka-shi (JP); Shingo MIYAKE, Hitachinaka-shi (JP); Sadatomo MATSUMURA, Hitachinaka-shi (JP); Ryo SHINATA, Hitachinaka-shi (JP)

(21) Appl. No.: 18/689,888

(22) PCT Filed: Sep. 16, 2022
(86) PCT No.: PCT/JP2022/034686

§ 371 Date: Mar. 7, 2024

(30) Foreign Application Priority Data
Sep. 28, 2021 (JP) 2021-157446

(51) Int. Cl. F16F 9/58

(52) U.S. Cl. CPC F16F 9/58

(57) ABSTRACT

A cylinder device includes a piston rod having one end side connected to a piston and the other end side inserted through a blocking member, and extending to the outside of a cylinder, and a cushion member provided between the piston and the blocking member and abutting the blocking member through extension of the piston rod. The cushion member has a first member, and a second member provided inside the first member in a radial direction, abutting the blocking member earlier than the first member and having a hardness smaller than that of the first member, and the first member and the second member apply a force to the blocking member in parallel.

### TECHNICAL FIELD

The present invention relates to a cylinder device.

Priority is claimed on Japanese Patent Application No. 2021-157446, filed Sep. 28, 2021, the content of which is incorporated herein by reference.

### BACKGROUND ART

In a cylinder device, a cushion configured to attenuate a shock upon full extension of a piston rod is provided (for example, see Patent Documents 1 to 3).

### CITATION LIST

### Patent Document

### Patent Document 1

Japanese Unexamined Patent Application, First Publication No. H9-14328

### Patent Document 2

Japanese Unexamined Patent Application, First Publication No. H8-233020

### Patent Document 3

Japanese Unexamined Patent Application, First Publication No. 2006-46509

### SUMMARY OF INVENTION

### Technical Problem

In the cylinder device, it is required to effectively attenuate a shock upon full extension of the piston rod with a compact configuration.

Accordingly, the present invention is directed to providing a cylinder device capable of effectively attenuating a shock upon full extension of a piston rod with a compact configuration.

### Solution to Problem

In order to achieve the aforementioned objects, a cylinder device of a first aspect according to the present invention includes a cylinder in which a working fluid is sealed; a piston slidably provided in the cylinder; a blocking member provided on the side of an opening portion of the cylinder; a piston rod having one end side connected to the piston and the other end side inserted through the blocking member and extending to the outside of the cylinder; and a cushion member provided between the piston and the blocking member and abutting the blocking member through extension of the piston rod. The cushion member has: a first member; and a second member provided inside the first member in the radial direction, abutting the blocking member earlier than the first member and having a hardness smaller than that of the first member, and the first member and the second member apply a force to the blocking member in parallel.

A cylinder device of a second aspect according to the present invention includes: a cylinder in which a working fluid is sealed; a piston slidably provided in the cylinder; a blocking member provided on the side of an opening portion of the cylinder; a piston rod having one end side connected to the piston and the other end side inserted through the blocking member, and extending to the outside of the cylinder; and a cushion member provided between the piston and the blocking member and abutting the blocking member through extension of the piston rod. The cushion member has: a first member; and a second member having a hardness smaller than that of the first member, and the cylinder device has first load characteristics generated after the second member abuts the blocking member, and second load characteristics generated after the second member and the first member abut the blocking member and having a load greater than that of the first load characteristics.

### Advantageous Effects of Invention

According to the present invention, it is possible to effectively attenuate a shock upon full extension of the piston rod with a compact configuration.

### BRIEF DESCRIPTION OF DRAWINGS

FIG. 1 is a cross-sectional view showing a cylinder device of a first embodiment according to the present invention.

FIG. 2 is a partially enlarged cross-sectional view of the cylinder device of the first embodiment according to the present invention.

FIG. 3 is a cross-sectional view taken along line III-III of FIG. 2 showing a major part of the cylinder device of the first embodiment according to the present invention.

FIG. 4 is a partially enlarged cross-sectional view of a cylinder device of a second embodiment according to the present invention.

FIG. 5 is a cross-sectional view showing a major part of a cylinder device of a third embodiment according to the present invention.

FIG. 6 is a cross-sectional view showing a major part of a cylinder device of a fourth embodiment according to the present invention.

FIG. 7 is a cross-sectional view showing a major part of a cylinder device of a fifth embodiment according to the present invention.

### DESCRIPTION OF EMBODIMENTS

### First embodiment

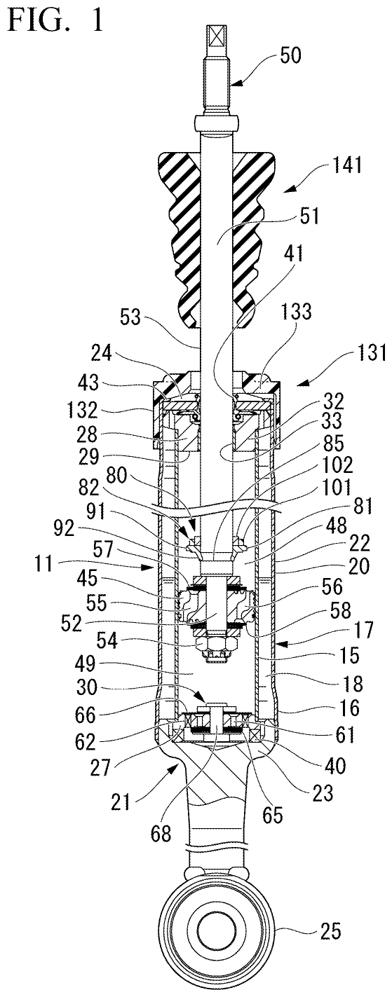

A cylinder device of a first embodiment will be described below with reference to FIG. 1 to FIG. 3.

FIG. 1 is a view showing a cylinder device 11 of the first embodiment and peripheral parts thereof. The cylinder device 11 is a shock absorber used in a suspension device of a vehicle such as an automobile, a railway vehicle, or the like. The cylinder device 11 is specifically a hydraulic shock absorber used in the suspension device of the automobile. The cylinder device 11 is a multi-cylinder type hydraulic shock absorber including a cylinder 17 having an inner cylinder 15 and an outer cylinder 16. The inner cylinder 15 has a cylindrical shape. The outer cylinder 16 has a bottomed cylindrical shape with a diameter larger than that of the inner cylinder 15. The outer cylinder 16 is provided coaxially with the inner cylinder 15 outside the inner cylinder 15 in a radial direction. A reservoir chamber 18 is provided between the outer cylinder 16 and the inner cylinder 15.

The outer cylinder 16 has a trunk member 20 and a bottom member 21. The trunk member 20 has a cylindrical shape. The bottom member 21 has an outer circumferential portion formed in a cylindrical shape, and is fixed by fitting and welding the outer circumferential portion to one end portion of the trunk member 20 in the axial direction. The fitting portion of the bottom member 21 to the trunk member 20 constitutes a cylindrical trunk section 22 of the outer cylinder 16 together with the trunk member 20. A portion of the bottom member 21 inside the fitting portion to the trunk member 20 in the radial direction constitutes a bottom portion 23 of the outer cylinder 16. The bottom portion 23 closes one end portion of the trunk section 22 in the axial 5 direction. A side of the trunk section 22 opposite to the bottom portion 23 in the axial direction is an opening portion 24. The opening portion 24 of the outer cylinder 16 is an opening portion also provided on one end of the cylinder 17 in the axial direction. The bottom portion 23 of the outer cylinder 16 is a bottom portion also provided on the other end of the cylinder 17 in the axial direction. In other words, one end of the 10 cylinder 17 in the axial direction is open, and the other end in the axial direction is closed. An inner portion of the bottom portion 23 in the radial direction extends toward a direction opposite to the trunk member 20 in the axial direction. A mounting eye 25 is fixed to a tip of an extension portion of the bottom portion 23. The mounting eye 25 is a portion connected to a wheel side of the vehicle. The inner cylinder 15 is an integrally 15 molded product consisting of one member made of a metal, and has a cylindrical shape. The inner circumferential surface of the inner cylinder 15 has a cylindrical surface shape.

The cylinder device 11 includes a valve body 27 and a rod guide 28 (blocking member). The valve body 27 has an annular shape and is provided on one end portion 20 of the inner cylinder 15 and the outer cylinder 16 in the axial direction. The rod guide 28 has an annular shape and is provided on the other end portion of the inner cylinder 15 and the outer cylinder 16 in the axial direction. The valve body 27 constitutes a base valve 30, and has an outer circumferential portion formed in a stepped shape with a large diameter portion and a small diameter portion having a diameter smaller than the large 25 diameter portion. The valve body 27 is placed on the bottom portion 23. Here, the valve body 27 is positioned in the large diameter portion of the outer circumferential portion with respect to the outer cylinder 16 in the radial direction.

The rod guide 28 has a rod guide main body 32 and a collar 33. The rod guide main body 32 is formed of a metal in an annular shape. The outer circumferential portion of the rod guide main body 32 is formed in a stepped shape having a large diameter portion and a small diameter portion having a diameter smaller than that of the large diameter portion. The collar 33 has a cylindrical shape. The collar 33 is made by covering an inner circumferential surface of a metal cylindrical body with a highly slidable material. The collar 33 is fitted and fixed to the inner circumferential portion of the rod guide main body 32. In the rod guide 28, the large diameter portion of the outer circumferential portion of the rod guide main body 32 is fitted to the inner circumferential portion of the trunk section 22 of the outer cylinder 16 on the side of the opening portion 24. The rod guide 28 has a planar end surface 29 that is an end portion on the side of the bottom portion 23 in the axial direction. The end surface 29 widens in a plane perpendicular to a center axis of the rod guide 28. The end surface 29 is formed on the rod guide main body 32 and the collar 33.

The inner cylinder 15 has one end portion in the axial direction that is fitted to the small diameter portion of the outer circumferential portion of the valve body 27. The inner cylinder 15 has one end portion in the axial direction that is placed on the bottom portion 23 of the outer cylinder 16 via the valve body 27. In addition, the inner cylinder 15 has the other end portion in the axial direction that is fitted to the small diameter portion of the outer circumferential portion of the rod guide main body 32.

The other end portion of the inner cylinder 15 is fitted to the trunk section 22 of the outer cylinder 16 via the rod guide 28. In this state, the inner cylinder 15 is positioned with respect to the outer cylinder 16 in the axial direction and the radial direction. Here, a space between the valve body 27 and the bottom portion 23 communicates with a space between the inner cylinder 15 and the outer cylinder 16 via a passage groove 40 formed in the valve body 27. The space between the valve body 27 and the bottom portion 23 configure the reservoir chamber 18, like the space between the inner cylinder 15 and the outer cylinder 16.

The cylinder device 11 includes a seal member 41 (blocking member). The seal member 41 is provided on a side of the rod guide 28 opposite to the bottom portion 23. The seal member 41 has an annular shape and is fitted to the inner circumferential portion of the trunk section 22 like the rod guide 28. A locking portion 43 is formed on an end portion of the trunk section 22 opposite to the bottom portion 23. The locking portion 43 is formed by plastically deforming the trunk member 20 inward in the radial direction through caulking such as curl processing or the like. The seal member 41 is sandwiched between the locking portion 43 and the rod guide 28. Here, the seal member 41 is pressed against the inner circumferential surface of the trunk section 22 by the rod guide 28. Accordingly, the seal member 41 closes a gap with the outer cylinder 16. The seal member 41 is, specifically, an oil seal. A portion of the outer cylinder 16 inside the locking portion 43 in the radial direction is the opening portion 24 of the outer cylinder 16.

The cylinder device 11 includes a piston 45. The piston 45 is slidably provided in the inner cylinder 15 of the cylinder 17. The piston 45 divides the inside of the inner cylinder 15 into two chambers, i.e., a first chamber 48 and a second chamber 49. The first chamber 48 is provided between the piston 45 in the inner cylinder 15 and the rod guide 28. The second chamber 49 is provided between the piston 45 in the inner cylinder 15 and the valve body 27. The second chamber 49 is separated from the reservoir chamber 18 by the valve body 27. In the cylinder 17, oil liquid as a working fluid is sealed in the first chamber 48 and the second chamber 49. In the cylinder 17, oil liquid as a working fluid and a gas are sealed in the reservoir chamber 18.

The cylinder device 11 includes a piston rod 50. A portion of the piston rod 50 on one end side in the axial direction is inserted into the cylinder 17. The portion of the piston rod 50 on the one end side is connected to the piston 45. A portion of the piston rod 50 on the other end side in the axial direction is inserted through the rod guide 28 and the seal member 41 to extend from the opening portion 24 of the outer cylinder 16 to the outside of the cylinder 17. The piston rod 50 is formed of a metal and passes through the first chamber 48. The piston rod 50 does not pass through the second chamber 49.

Accordingly, the first chamber 48 is a rod-side chamber through which the piston rod 50 passes. The second chamber 49 is a bottom-side chamber on the side of the bottom portion 23 of the cylinder 17. A portion of the piston rod 50 extending from the cylinder 17 to the outside is connected to a vehicle body side of the vehicle.

The piston rod 50 has a main shaft portion 51 and an attachment shaft portion 52. The attachment shaft portion 52 extends in the axial direction of the main shaft portion 51 from one end of the main shaft portion 51 in the axial direction. The attachment shaft portion 52 has an outer diameter smaller than that of the main shaft portion 51. The main shaft portion 51 has an outer circumferential surface portion 53 having a cylindrical surface shape. The piston rod 50 is inserted into the cylinder 17 on the side of the attachment shaft portion 52. In the piston rod 50, the piston 45 is connected and fixed to the attachment shaft portion 52 by a nut 54. The piston rod 50 protrudes outward from the cylinder 17 through the rod guide 28 and the seal member 41 in the main shaft portion 51. The rod guide 28 and the seal member 41 are provided on an end portion of the cylinder 17 from which the piston rod 50 extends.

The rod guide 28 positions the piston rod 50 in the radial direction and supports the piston rod 50 so as to be slidable in the axial direction. The piston rod 50 is guided to the rod guide 28 in the outer circumferential surface portion 53 of the main shaft portion 51. The end surface 29 of the rod guide 28 widens in a plane perpendicular to the outer circumferential surface portion 53 of the piston rod 50. The piston rod 50 moves with respect to the cylinder 17 integrally with the piston 45 in the axial direction. In the extension stroke of the cylinder device 11 in which the piston rod 50 increases the protrusion amount from the cylinder 17, the piston 45 moves toward the first chamber 48.

In the contraction stroke of the cylinder device 11 in which the piston rod 50 reduces the protrusion amount from the cylinder 17, the piston 45 moves toward the second chamber 49.

In the piston rod 50, the outer circumferential surface portion 53 of the main shaft portion 51 slides against the inner circumferential portion of the seal member 41. Here, the seal member 41 closes a gap with the piston rod 50. The seal member 41 seals the space between the trunk section 22 of the outer cylinder 16 and the main shaft portion 51 of the piston rod 50 using the rod guide 28, and restricts a leakage of the oil liquid in the inner cylinder 15 and the gas and oil liquid in the reservoir chamber 18 to the outside. The rod guide 28 and the seal member 41 are provided on the side of the opening portion 24 of the cylinder 17, one end of which is the opening portion 24 and the other end of which is closed, to block the opening portion 24.

A passage 55 and a passage 56 are formed in the piston 45. Both the passage 55 and the passage 56 pass through the piston 45 in the axial direction. The passages 55 and 56 can bring the first chamber 48 and the second chamber 49 in communication with each other. The cylinder device 11 includes a disk valve 57 and a disk valve 58. The disk valve 57 is provided on a side of the piston 45 opposite to the bottom portion 23 in the axial direction. The disk valve 57 has an annular shape and abuts the piston 45 to block the passage 55. The disk valve 58 is provided on the side of the bottom portion 23 of the piston 45 in the axial direction. The disk valve 58 has an annular shape and abuts the piston 45 to block the passage 56. The disk valves 57 and 58 are attached to the piston rod 50 together with the piston 45.

When the piston rod 50 moves to the contraction side that increases the amount of penetration into the inner cylinder 15 and the outer cylinder 16 and the piston 45 moves in the direction of narrowing the second chamber 49, the pressure in the second chamber 49 becomes higher than the pressure in the first chamber 48. Then, the disk valve 57 opens the passage 55 and the oil liquid of the second chamber 49 flows to the first chamber 48. Here, the disk valve 57 generates a damping force. When the piston rod 50 moves to the extension side that increases the protrusion amount from the inner cylinder 15 and the outer cylinder 16 and the piston 45 moves in the direction of narrowing the first chamber 48, the pressure in the first chamber 48 becomes higher than the pressure in the second chamber 49. Then, the disk valve 58 opens the passage 56 and the oil liquid of the first chamber 48 flows to the second chamber 49. Here, the disk valve 58 generates a damping force.

A fixed orifice (not shown) is formed in at least one of the piston 45 and the disk valve 57. The fixed orifice brings the first chamber 48 and the second chamber 49 in communication with each other via the passage 55 even in a state in which the disk valve 57 has blocked the passage 55 the most. In addition, the fixed orifice (not shown) is also formed in at least one of the piston 45 and the disk valve 58. The fixed orifice brings the first chamber 48 and the second chamber 49 in communication with each other via the passage 56 even in a state in which the disk valve 58 has blocks the passage 56 the most.

A liquid passage 61 and a liquid passage 62 are formed in the valve body 27. Both the liquid passage 61 and the liquid passage 62 pass through the valve body 27 in the axial direction. Both the liquid passages 61 and 62 can also bring the second chamber 49 and the reservoir chamber 18 in communication with each other. The base valve 30 includes a disk valve 65 and a disk valve 66. The disk valve 65 is provided on the side of the bottom portion 23 in the axial direction of the valve body 27. The disk valve 65 abuts the valve body 27 and blocks the liquid passage 61. The disk valve 66 is provided on a side of the valve body 27 in the axial direction opposite to the bottom portion 23. The disk valve 66 abuts the valve body 27 and blocks the liquid passage 62. The base valve 30 has a pin 68. The pin 68 attaches the disk valves 65 and 66 to the valve body 27. The valve body 27, the disk valves 65 and 66, the pin 68, and the like, constitute the base valve 30.

When the piston rod 50 moves to the contraction side and the piston 45 moves in the direction of narrowing the second chamber 49, the pressure in the second chamber 49 becomes higher than the pressure in the reservoir chamber 18. Then, the base valve 30 causes the disk valve 65 to open the liquid passage 61 and allows the oil liquid in the second chamber 49 to flow into the reservoir chamber 18. Here, the disk valve 65 generates a damping force. When the piston rod 50 moves to the extension side and the piston 45 moves toward the first chamber 48, the pressure in the second chamber 49 becomes lower than the pressure in the reservoir chamber 18. Then, the base valve 30 causes the disk valve 66 to open the liquid passage 62, and allows the oil liquid in the reservoir chamber 18 to follow into the second chamber 49. The disk valve 66 is a suction valve that allows the oil liquid to flow from the reservoir chamber 18 into the second chamber 49 without substantially generating a damping force at this time.

The cylinder device 11 includes a rebound stopper 80. The rebound stopper 80 includes a stopper member 81 and a cushion member 82. Here, an engaging groove 85 is formed in the main shaft portion 51 of the piston rod 50. The engaging groove 85 is recessed inward from the outer circumferential surface portion 53 of the main shaft portion 51 in the radial direction. The engaging groove 85 is an annular shape coaxial with the outer circumferential surface portion 53 of the main shaft portion 51. The engaging groove 85 is formed in an area disposed in the inner cylinder 15 of the main shaft portion 51 and an area disposed between the piston 45 and the rod guide 28.

The stopper member 81 is formed of a metal and has an abutting portion 91 and an engaging portion 92. The abutting portion 91 has a perforated disk shape. The engaging portion 92 has a cylindrical shape and protrudes from the inner circumferential edge portion of the abutting portion 91 to one side of the abutting portion 91 in the axial direction. The stopper member 81 allows the main shaft portion 51 of the piston rod 50 to be inserted inward in the radial direction in a state in which the engaging portion 92 has the cylindrical shape. Here, the stopper member 81 causes a position of the engaging portion 92 to overlap the engaging groove 85 in the axial direction of the piston rod 50. In addition, here, the stopper member 81 is oriented such that the engaging portion 92 is located closer to the attachment shaft portion 52 than the abutting portion 91 in the axial direction of the piston rod 50. In this state, the stopper member 81 is plastic deformed by caulking the engaging portion 92 inward in the radial direction. Accordingly, the stopper member 81 is fixed to the piston rod 50 with the engaging portion 92 entering the engaging groove 85 of the main shaft portion 51.

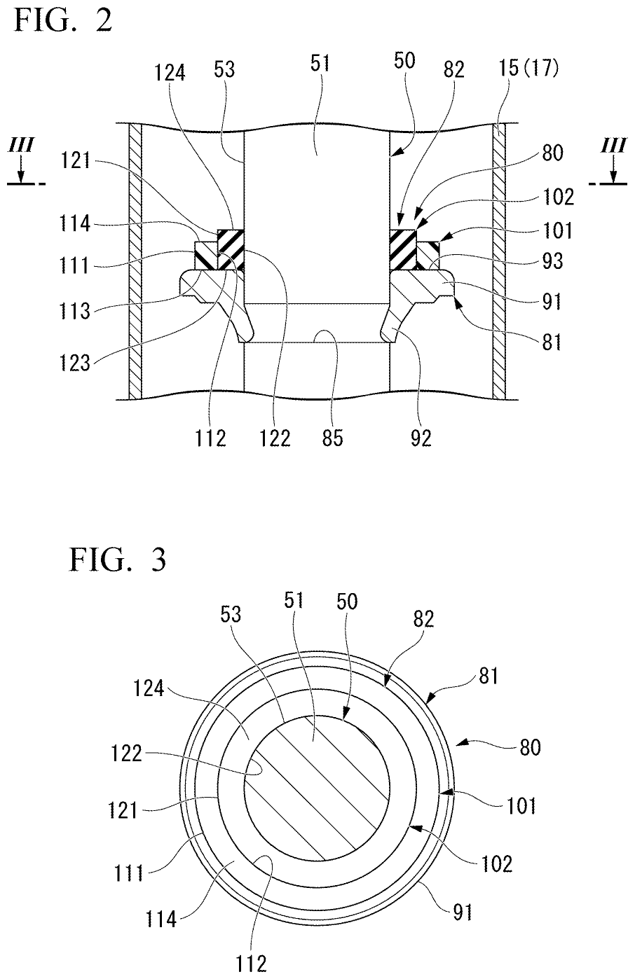

In the stopper member 81, the abutting portion 91 is located closer to the rod guide 28 than the engaging portion 92 in the axial direction of the piston rod 50. As shown in FIG. 2, an end portion of the abutting portion 91 opposite to the engaging portion 92 in the axial direction is an abutting surface 93. The abutting surface 93 has a planar shape and widens in a plane perpendicular to a center axis of the piston rod 50. The abutting surface 93 of the abutting portion 91 faces the end surface 29 of the rod guide 28 shown in FIG. 1 in the axial direction of the piston rod 50.

The cushion member 82 has a first shock absorbing member 101 (first member) and a second shock absorbing member 102 (second member).

The first shock absorbing member 101 is an elastic member formed in a ring shape, specifically, an annular shape. As shown in FIG. 2, the first shock absorbing member 101 has an outer circumferential surface portion 111, an inner circumferential surface portion 112, an end surface portion 113, and an end surface portion 114.

The outer circumferential surface portion 111 has a cylindrical surface shape. The inner circumferential surface portion 112 has a cylindrical surface shape. The outer circumferential surface portion 111 and the inner circumferential surface portion 112 are disposed coaxially.

The end surface portion 113 has a planar shape. The end surface portion 113 widens inward in the radial direction of the outer circumferential surface portion 111 from one edge portion of the outer circumferential surface portion 111 in the axial direction to be connected to one edge portion of the inner circumferential surface portion 112 in the axial direction. The end surface portion 113 widens in a plane perpendicular to center axes of the outer circumferential surface portion 111 and the inner circumferential surface portion 112. The end surface portion 114 has a planar shape. The end surface portion 114 widens inward in the radial direction of the outer circumferential surface portion 111 from an edge portion of the outer circumferential surface portion 111 opposite to the end surface portion 113 in the axial direction and connected to an edge portion of the inner circumferential surface portion 112 opposite to the end surface portion 113 in the axial direction. The end surface portion 114 widens in a plane perpendicular to the center axes of the outer circumferential surface portion 111 and the inner circumferential surface portion 112. The end surface portion 113 and the end surface portion 114 are parallel to each other.

The second shock absorbing member 102 is an elastic member formed in a ring shape, specifically, an annular shape. The second shock absorbing member 102 has an outer circumferential surface portion 121, an inner circumferential surface portion 122, an end surface portion 123, and an end surface portion 124.

The outer circumferential surface portion 121 has a cylindrical surface shape. The inner circumferential surface portion 122 has a cylindrical surface shape. A diameter of the outer circumferential surface portion 121, i.e., an outer diameter of the second shock absorbing member 102 is slightly greater than a diameter of the inner circumferential surface portion 112, i.e., an inner diameter of the first shock absorbing member 101. A diameter of the inner circumferential surface portion 122, i.e., an inner diameter of the second shock absorbing member 102 is slightly smaller than a diameter of the outer circumferential surface portion 53 of the main shaft portion 51 of the piston rod 50, i.e., an outer diameter of the main shaft portion 51. The outer circumferential surface portion 121 and the inner circumferential surface portion 122 are disposed coaxially.

The end surface portion 123 has a planar shape. The end surface portion 123 widens inward in the radial direction of the outer circumferential surface portion 121 from one edge portion of the outer circumferential surface portion 121 in the axial direction and connected to one edge portion of the inner circumferential surface portion 122 in the axial direction. The end surface portion 123 widens in a plane perpendicular to the center axes of the outer circumferential surface portion 121 and the inner circumferential surface portion 122. The end surface portion 124 has a planar shape.

The end surface portion 124 widens inward in the radial direction of the outer circumferential surface portion 121 from an edge portion of the outer circumferential surface portion 121 opposite to the end surface portion 123 in the axial direction and connected to an edge portion of the inner circumferential surface portion 122 opposite to the end surface portion 123 in the axial direction. The end surface portion 124 widens in a plane perpendicular to the center axes of the outer circumferential surface portion 121 and the inner circumferential surface portion 122. The end surface portion 123 and the end surface portion 124 are parallel to each other.

A length of the second shock absorbing member 102 in the axial direction is greater than that of the first shock absorbing member 101 in the axial direction. In other words, the first shock absorbing member 101 has a shaft length smaller than that of the second shock absorbing member 102. Further, in other words, a distance between the end surface portions 123 and 124 is greater than that between the end surface portions 113 and 114. A difference between the outer diameter and the inner diameter of the second shock absorbing member 102 is equal to that that between the outer diameter and the inner diameter of the first shock absorbing member 101. In other words, a thickness of the second shock absorbing member 102 in the radial direction is equal to that of the first shock absorbing member 101 in the radial direction.

The second shock absorbing member 102 is disposed inside the first shock absorbing member 101 in the radial direction. Here, the outer circumferential surface portion 121 of the second shock absorbing member 102 abuts the inner circumferential surface portion 112 of the first shock absorbing member 101 over the entire circumference. The second shock absorbing member 102 is fitted inside the first shock absorbing member 101 in the radial direction with an interference margin. Accordingly, the cushion member 82 is formed coaxially with the first shock absorbing member 101 and the second shock absorbing member 102 and configured integrally therewith. The end surface portion 123 of the second shock absorbing member 102 and the end surface portion 113 of the first shock absorbing member 101 are aligned in the axial direction of the first shock absorbing member 101 and the second shock absorbing member 102.

Accordingly, in the axial direction of the first shock absorbing member 101 and the second shock absorbing member 102, the end surface portion 124 of the second shock absorbing member 102 is located on an opposite side of the end surface portions 113 and 123 from the end surface portion 114 of the first shock absorbing member 101.

As shown in FIG. 1, in the cushion member 82, the first shock absorbing member 101 and the second shock absorbing member 102 are disposed between the rod guide 28 and the stopper member 81 in a state in which the piston rod 50 is inserted through the second shock absorbing member 102 in the radial direction. Accordingly, the first shock absorbing member 101 and the second shock absorbing member 102 are provided between the piston 45 and the rod guide 28 in the axial direction of the piston rod 50. In other words, the cushion member 82 having the first shock absorbing member 101 and the second shock absorbing member 102 is provided between the piston 45 and the rod guide 28. Here, the second shock absorbing member 102 is fitted onto the main shaft portion 51 of the piston rod 50 with an interference margin. In other words, the inner circumferential surface portion 122 shown in FIG. 2 is pressed against the outer circumferential surface portion 53 of the main shaft portion 51. In addition, here, the first shock absorbing member 101 and the second shock absorbing member 102 cause the end surface portion 113 and the end surface portion 123 to face and abut the abutting surface 93 of the stopper member 81 in the axial direction of the piston rod 50. The first shock absorbing member 101 and the second shock absorbing member 102 cause the end surface portion 114 and the end surface portion 124 to face the end surface 29 of the rod guide 28 shown in FIG. 1 in the axial direction of the piston rod 50. Further, the second shock absorbing member 102 may have a gap with respect to the outer circumferential surface portion 53 of the piston rod 50 in the radial direction.

The cushion member 82 having the first shock absorbing member 101 and the second shock absorbing member 102 abut the rod guide 28 through extension of the piston rod 50 from the rod guide 28 and the seal member 41. Here, the first shock absorbing member 101 and the second shock absorbing member 102 cause the second shock absorbing member 102 to abut the rod guide 28 before the first shock absorbing member 101. Specifically, when the piston rod 50 is located at a first predetermined position on the full extension side with respect to the rod guide 28, in the cushion member 82 abutting the stopper member 81, the second shock absorbing member 102 abuts the end surface 29 of the rod guide 28 shown in FIG. 1 in the end surface portion 124 shown in FIG. 2. When the piston rod 50 moves further toward the full extension side than the first predetermined position with respect to the rod guide 28, the second shock absorbing member 102 is compressively deformed in the axial direction.

Accordingly, a moving speed of the piston rod 50 with respect to the rod guide 28 is suppressed. When the piston rod 50 is located at a second predetermined position, which is further toward the full extension side than a first predetermined position with respect to the rod guide 28, in the cushion member 82, the first shock absorbing member 101 abuts the end surface 29 of the rod guide 28 shown in FIG. 1 in the end surface portion 114 shown in FIG. 2. When the piston rod 50 moves further toward the full extension than the second predetermined position with respect to the rod guide 28, both the second shock absorbing member 102 and the first shock absorbing member 101 are compressively deformed in the axial direction. Accordingly, a moving speed of the piston rod 50 with respect to the rod guide 28 is further suppressed. Finally, when the cushion member 82 is compressed and deformed to the limit in the axial direction, the piston rod 50 stops relative to the rod guide 28, that is, the cylinder 17.

In this way, when the piston rod 50 moves to the first predetermined position on the full extension side with respect to the rod guide 28, the second shock absorbing member 102 abuts the rod guide 28 earlier than the first shock absorbing member 101, and then, the piston rod 50 further moves to the full extension side with respect to the rod guide 28, causing the second shock absorbing member 102 to elastically deform in the axial direction. After that, when the piston rod 50 further moves to the second predetermined position on the full extension side than the first predetermined position with respect to the rod guide 28, the first shock absorbing member 101 abuts the rod guide 28, and then, the piston rod 50 further moves to full extension side with respect to the rod guide 28, causing both the second shock absorbing member 102 and the first shock absorbing member 101 to elastically deform in the axial direction. Here, the first shock absorbing member 101 and the second shock absorbing member 102 apply forces to the rod guide 28 in parallel.

In other words, in the cylinder device 11, the cushion member 82 causes both the first shock absorbing member 101 and the second shock absorbing member 102 to be disposed on an outer circumferential side and an inner circumferential side such that flexibility and load are applied to the rod guide 28 in parallel. In addition, in the cylinder device 11, since lengths of the first shock absorbing member 101 and the second shock absorbing member 102 in the axial direction are different from each other, abutting timings of first shock absorbing member 101 and the second shock absorbing member 102 with respect to the rod guide 28 are different.

The first shock absorbing member 101 and the second shock absorbing member 102 are formed of different cushion materials having different hardness. The hardness of the second shock absorbing member 102 is smaller than that of the first shock absorbing member 101. Accordingly, in the first shock absorbing member 101 and the second shock absorbing member 102, the second shock absorbing member 102 formed of a soft material abuts the rod guide 28 earlier than the first shock absorbing member 101 formed of a hard material. Moreover, in the cylinder device 11, the cushion member 82 is disposed such that, in the first shock absorbing member 101 and the second shock absorbing member 102, the second shock absorbing member 102 formed of the soft material is disposed on an inner side in the radial direction and the first shock absorbing member 101 formed of the hard material is disposed on an outer side in the radial direction.

In this way, the first shock absorbing member 101 has the hardness greater than that of the second shock absorbing member 102. In the first shock absorbing member 101, a load received by a unit deformation length in the axial direction is greater than that of the second shock absorbing member 102. The first shock absorbing member 101 is formed of a resin. The first shock absorbing member 101 is formed of, specifically, PA66 (Nylon 66). The first shock absorbing member 101 may be formed of, in addition to PA66, for example, PC (polycarbonate), PA6 (Nylon 6), POM (polyacetal), PBT (polybutylene terephthalate), PPA (polyphthalamide), PPS (polyphenylene sulfide), PEEK (polyetheretherketone), PTFE (polytetrafluoroethylene), PFA (perfluoroalkoxyalkane), or the like, or these materials including a filling material with a reinforcement effect such as a carbon-based reinforcement material, a glass fiber or the like. In addition, the first shock absorbing member 101 may be formed of, for example,

PE (polyethylene)-based TPEE (thermoplastic elastomer), PA (Nylon)-based TPEE, PP (polypropylene)-based TPEE, U (urethane)-based TPEE, CFRP (carbon fiber reinforced plastic), FKM (vinylidene fluoride fluororubber), or the like, or these materials including a filling material with a reinforcement effect such as a carbon-based reinforcement material, a glass fiber, or the like.

The second shock absorbing member 102 has the hardness smaller than that of the first shock absorbing member 101. The load received by the second shock absorbing member 102 per the unit deformation length in the axial direction is smaller than that by the first shock absorbing member 101. The second shock absorbing member 102 is formed of an elastomer with large flexibility. The second shock absorbing member 102 is formed of, specifically, NBR (nitrile rubber). The second shock absorbing member 102 may be formed of, in addition to NBR, for example, NR (natural rubber), IR (synthetic natural rubber), SBR (styrene butadiene rubber), BR (butadiene rubber), CR (chloroprene rubber), IIR (butyl rubber), EPDM (ethylene propylene rubber), CSM (chlorosulfonated polyethylene rubber), ACM (acrylic rubber), U (urethane rubber), H-NBR (hydrogenated nitrile rubber), VMQ (silicone rubber), FVMQ (fluoro-silicone rubber), FKM (fluoro-rubber), a mixed material of the above-mentioned rubbers, or the like, or these materials including a filling material with a reinforcement effect such as a carbon-based reinforcement material, a glass fiber, or the like. The second shock absorbing member 102 may be formed of, for example, PE-based TPEE, PA-based TPEE, PP-based TPEE, U-based TPEE, or these materials including a filling material with a reinforcement effect such as a carbon-based reinforcement material, a glass fiber, or the like.

Here, the first shock absorbing member 101 and the second shock absorbing member 102 may be formed integrally by fitting, or may be formed integrally by a molding step.

The cushion member 82 abuts the rod guide 28 through extension of the piston rod 50 from the rod guide 28 and the seal member 41. Here, in the cushion member 82, the second shock absorbing member 102 abuts the rod guide 28 earlier than the first shock absorbing member 101 and elastically deforms in the axial direction, and then, both the first shock absorbing member 101 and the second shock absorbing member 102 abuts the rod guide 28 together and elastically deform in the axial direction. For this reason, in the cushion member 82, the load received per the unit deformation length is greater in the second load characteristics generated after both the first shock absorbing member 101 and the second member abuts the rod guide 28 together than in the first load characteristics generated after the second shock absorbing member 102 abuts the rod guide 28. In other words, the cushion member 82 has the first load characteristics generated after the second shock absorbing member 102 abuts the rod guide 28, and the second load characteristics generated after the second shock absorbing member 102 and the first shock absorbing member 101 abut the rod guide 28 and having a load greater than that of the first load characteristics.

The side of the opening portion 24 of the outer cylinder 16 is covered with a bumper cap 131. The bumper cap 131 is an integrally molded synthetic resin product, and includes a mounting part 132 and a cover part 133. The mounting part 132 has a cylindrical shape. The cover part 133 has a perforated disk shape, and widens in the radial direction from the edge portion of the mounting part 132 on one end side in the axial direction. The mounting part 132 of the bumper cap 131 is fitted to the trunk member 20 of the outer cylinder 16 to cover the outer circumferential surface thereof. Accordingly, the bumper cap 131 is fixed to the outer cylinder 16. The cover part 133 of the bumper cap 131 covers the outer cylinder 16 on the side of the opening portion 24 and the seal member 41. The piston rod 50 is inserted inside the cover part 133 in the radial direction.

In the cylinder device 11 in a state in which the bumper cap 131 is attached, the piston rod 50 is connected to the vehicle body side, and the mounting eye 25 fixed to the outer cylinder 16 is connected to the wheel side. Then, a bump rubber 141 formed of an elastic resin material is disposed between the bumper cap 131 attached to the cylinder device 11 and the vehicle body side. The bump rubber 141 has a cylindrical bellows shape, and is supported on the vehicle body side with the main shaft portion 51 of the piston rod 50 inserted thereinto. The cover part 133 of the bumper cap 131 abuts the bump rubber 141, thereby preventing interference between the bump rubber 141 and the seal member 41.

The above-mentioned Patent Documents 1 to 3 disclose a cylinder device provided with a cushion configured to attenuate a shock upon full extension of a piston rod. For example, Patent Document 1 discloses a structure in which Nylon with a high hardness and NBR with a low hardness are connected in series. In addition, Patent Document 2 discloses a cylinder in which a cushion is disposed inside a storage part in order to prevent a cushion from getting caught in the inner periphery of the cylinder. In addition, Patent Document 3 discloses a cushion in which a deformation restriction member is received.

Incidentally, it is required to effectively attenuate a shock upon full extension of a piston rod with a compact configuration. In order to effectively attenuate the shock, for example, the load received per the unit deformation length in the axial direction is a high load, and moreover, it is better to provide a cushion with high flexibility that can flex significantly even with a small load. However, if a cushion is configured using only low rigidity members, it will become large even if the shape and size are devised. In addition, if a cushion is configured with only low rigidity members, the amount of collapse will be large when it is significantly deformed, it will be easily damaged, and it will be difficult to satisfy the durability requirements. Meanwhile, when a cushion is configured with only high rigidity members, even if the shape and size are devised, in order to satisfy the characteristics of high flexibility, it is necessary to arrange multiple members in series in the axial direction of the piston rod, which results in an increase in size, especially in the axial direction. For example, when a metal coil spring and an elastic body such as rubber are disposed in series, they cause causes occurrence of abnormal noise while increasing the size thereof. Accordingly, in either case, the cushion becomes large and it is difficult to achieve a compact configuration. As a result, it is difficult to apply this method to the cylinder device with a small cylinder diameter or the cylinder device that requires a shortened shaft length.

In the cylinder device 11 of the first embodiment, the cushion member 82 has the first shock absorbing member 101, and the second shock absorbing member 102 disposed inside the first shock absorbing member 101 in the radial direction, abutting the rod guide 28 earlier than the first shock absorbing member 101 and having the hardness smaller than that of the first shock absorbing member 101. Then, the cushion member 82 causes both the first shock absorbing member 101 and the second shock absorbing member 102 to apply a force against the rod guide 28 in parallel. Accordingly, the second shock absorbing member 102 having the hardness smaller than that of the first shock absorbing member 101 first abuts the rod guide 28 to be deformed, and thus, it is possible to obtain high flexibility characteristics such that the member is also largely flexed with a small load. Then, after that, the second shock absorbing member 102 and the first shock absorbing member 101 having the hardness greater than that thereof apply a force against the rod guide 28 in parallel. Accordingly, it is possible to obtain high load characteristics that increase the load received per the unit deformation length in the axial direction. Accordingly, the shock can be effectively attenuated by the cushion member 82. Moreover, compared to the case where the cushion member is constituted only by members with a low hardness, the member can be made more compact and its durability can be improved. In addition, compared to configuring the cushion member using only members with a high hardness, the member can be made more compact because there is no need to arrange multiple members in series. Further, since the second shock absorbing member 102 is located inside the first shock absorbing member 101 in the radial direction, the configuration becomes more compact and the cost becomes lower. Accordingly, it is possible to effectively attenuate the shock upon full extension of the piston rod 50 with a compact configuration.

In addition, the cylinder device 11 has first load characteristics generated after the second shock absorbing member 102 of the cushion member 82 abuts the rod guide 28, and second load characteristics generated after the second shock absorbing member 102 and the first shock absorbing member 101 abut the rod guide 28 and having a load greater than that of the first load characteristics. The first load characteristics are high flexibility characteristics that allow a large deflection even with a small load, and the second load characteristics are high load characteristics that increase the load received per the unit deformation length in the axial direction. Accordingly, the shock can be effectively attenuated by the cushion member 82. Moreover, the cushion member can be made more compact and its durability can be improved compared to the case where the cushion member is constituted only by members with a small hardness. In addition, compared to the case where the cushion member is constituted by only by members with a high hardness, since there is no need to arrange multiple members in series, the cushion member can be made more compact. Accordingly, it is possible to effectively attenuate the shock upon full extension of the piston rod using the cushion member with a compact configuration.

In addition, in the cylinder device 11, both the first shock absorbing member 101 and the second shock absorbing member 102 are formed in an annular shape, and the second shock absorbing member 102 is disposed on an inner circumferential side of the first shock absorbing member 101. For this reason, in the first shock absorbing member 101 and the second shock absorbing member 102, even if the second shock absorbing member 102, which abuts the rod guide 28 first, is greatly crushed, the first shock absorbing member 101 suppresses its outward deformation in the radial direction. In addition, even if the second shock absorbing member 102 swells, the first shock absorbing member 101 suppresses its outward deformation in the radial direction.

Accordingly, when the diameter of the cylinder device 11 is particularly reduced, it is possible to prevent the second shock absorbing member 102 from coming into contact with the inner cylinder 15. As a result, a so-called hydraulic lock state in which the cushion member 82 comes into contact with the inner cylinder 15 to obstruct a flow of the oil liquid on both sides of the cushion member 82 and obstruct the piston rod 50 from moving toward the bottom portion 23 can be prevented.

In addition, in the cylinder device 11, the first shock absorbing member 101 has a shaft length smaller than that of the second shock absorbing member 102. For this reason, the second shock absorbing member 102 can easily abut the rod guide 28 earlier than the first shock absorbing member 101.

In addition, the cylinder device 11 has the first shock absorbing member 101 and the second shock absorbing member 102, which are configured integrally. For this reason, attachment to the piston rod 50 and parts management become easier. Further, by forming the first shock absorbing member 101 and the second shock absorbing member 102 integrally upon molding, a process just for integrating these can be omitted.

In addition, in the cylinder device 11, since the rebound stopper 80 does not have a metal coil spring, it is possible to suppress occurrence of abnormal noise.

### Second Embodiment

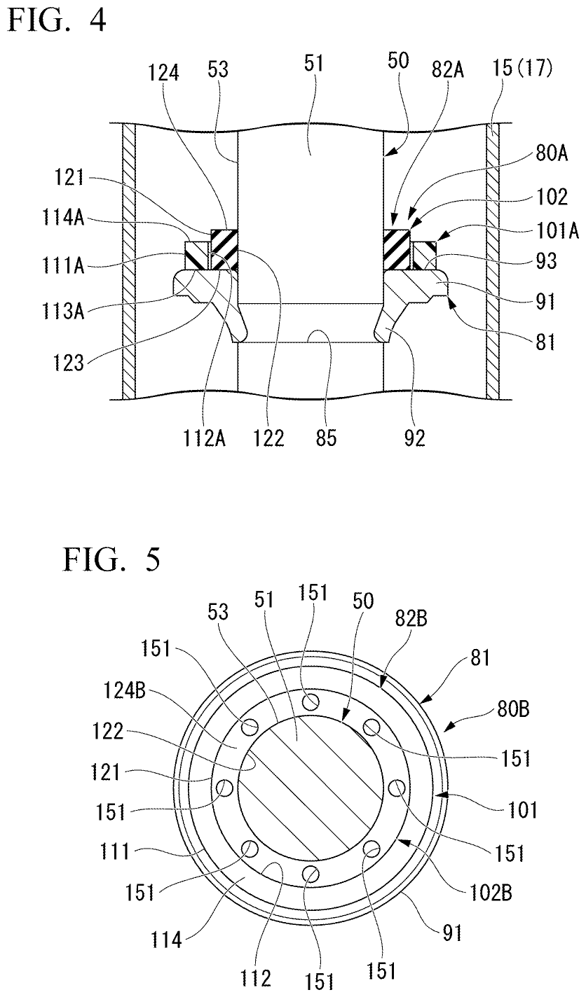

Next, a second embodiment will be described mainly with reference to FIG. 4, focusing on differences from the first embodiment. Further, parts that are common with the first embodiment are expressed by the same names and reference signs.

In the second embodiment, a rebound stopper 80A, which is partially different from the rebound stopper 80, is provided in place of the rebound stopper 80. The rebound stopper 80A has a cushion member 82A, which is partially different from the cushion member 82, instead of the cushion member 82. The cushion member 82A has a first shock absorbing member 101A (first member), which is partially different from the first shock absorbing member 101, instead of the first shock absorbing member 101.

The first shock absorbing member 101A has an outer circumferential surface portion 111A, an inner circumferential surface portion 112A, an end surface portion 113A, and an end surface portion 114A. The outer circumferential surface portion 111A is distinguished from the outer circumferential surface portion 111 in that a diameter thereof is greater than that of the outer circumferential surface portion 111. The inner circumferential surface portion 112A is distinguished from the inner circumferential surface portion 112 in that a diameter thereof greater than that of the inner circumferential surface portion 112. The end surface portion 113A is distinguished from the end surface portion 113 in that an inner diameter thereof is greater than that of the end surface portion 113 and an outer diameter is greater than that of the end surface portion 113. The end surface portion 114A is distinguished from the end surface portion 114 in that an inner diameter thereof is greater than that of the end surface portion 114 and an outer diameter thereof is greater than that of the end surface portion 114.

A diameter of the inner circumferential surface portion 112A of the first shock absorbing member 101A, i.e., the inner diameter of the first shock absorbing member 101A is greater than a diameter of the outer circumferential surface portion 121, i.e., the outer diameter of the second shock absorbing member 102. Accordingly, when the second shock absorbing member 102 is disposed inside the first shock absorbing member 101A in the radial direction, a gap is provided with respect to the first shock absorbing member 101A in the radial direction. Accordingly, except when the second shock absorbing member 102 is deformed, the abutting portion of the outer circumferential surface portion 121 to the inner circumferential surface portion 112A of the first shock absorbing member 101A does not extend over the entire circumference the outer circumferential surface portion 121.

The rebound stopper 80A is also attached to the piston rod 50 in the same manner as the rebound stopper 80 and operates in the same manner as the rebound stopper 80.

### Third Embodiment

Next, a third embodiment will be described mainly with reference to FIG. 5, focusing on differences from the first embodiment. Further, parts that are common with the first embodiment are expressed by the same names and reference signs.

In the second embodiment, a rebound stopper 80B, which is partially different from the rebound stopper 80, is provided in place of the rebound stopper 80. The rebound stopper 80B has a cushion member 82B, which is partially different from the cushion member 82, instead of the cushion member 82. The cushion member 82B has a second shock absorbing member 102B (second member), which is partially different from the second shock absorbing member 102, instead of the second shock absorbing member 102.

A through-hole 151 passing through the second shock absorbing member 102B in the axial direction is formed in the second shock absorbing member 102B at a position between the outer circumferential surface portion 121 and the inner circumferential surface portion 122 in the radial direction. The plurality of (specifically, eight) through-holes 151 are formed in the second shock absorbing member 102B at equal intervals in the circumferential direction. Accordingly, the second shock absorbing member 102B has an end surface portion 124B distinguished from the end surface portion 124 in that the through-hole 151 is open. In addition, while not shown, the second shock absorbing member 102B has an end surface portion distinguished from the end surface portion 123 in that the through-hole 151 is open.

The rebound stopper 80B is also attached to the piston rod 50 in the same manner as the rebound stopper 80 and operates in the same manner as the rebound Since the plurality of through-holes 151 are formed, the rebound stopper 80B has the hardness smaller than that of the rebound stopper 80, and compressive deformation in the axial direction is facilitated. stopper 80.

### Fourth Embodiment

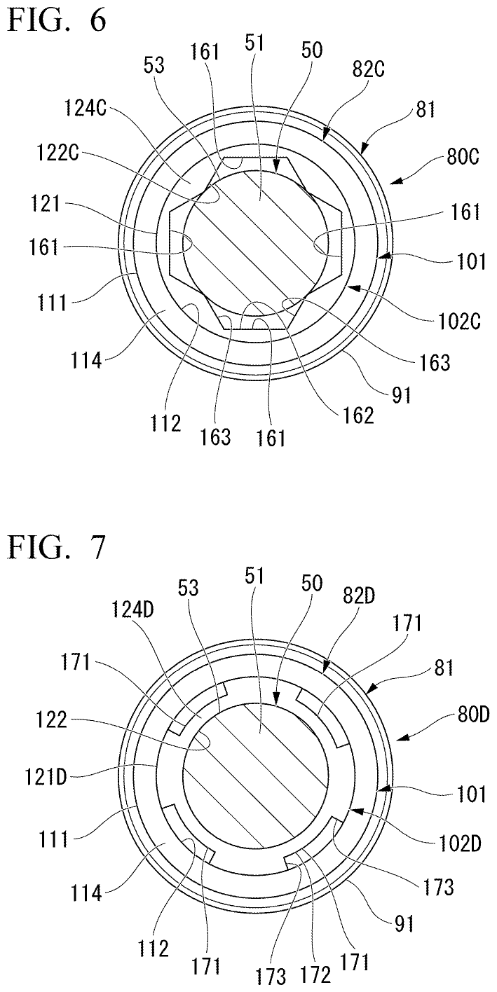

Next, a fourth embodiment will be described mainly with reference to FIG. 6, focusing on differences from the first embodiment. Further, parts that are common with the first embodiment are expressed by the same names and reference signs. In the fourth embodiment, a rebound stopper 80C, which is partially different from the rebound stopper 80, is provided in place of the rebound stopper 80. The rebound stopper 80C has a cushion member 82C, which is partially different from the cushion member 82, instead of the cushion member 82. The cushion member 82C has a second shock absorbing member 102C (second member), which is partially different from the second shock absorbing member 102, instead of the second shock absorbing member 102.

A groove section 161 is formed in an inner portion of the second shock absorbing member 102C in the radial direction. The groove section 161 extends in the axial direction of the second shock absorbing member 102C and passes through the second shock absorbing member 102C in the axial direction. The plurality of (specifically, four) groove sections 161 are formed in the second shock absorbing member 102C at equal intervals in the circumferential direction. Accordingly, the second shock absorbing member 102C has an inner circumferential surface portion 122C distinguished from the inner circumferential surface portion 122 in that the plurality of groove sections 161 are formed. In addition, the second shock absorbing member 102C has an end surface portion 124C distinguished from the end surface portion 124 in that the groove section 161 is open. In addition, while not shown, the second shock absorbing member 102C has an end surface portion distinguished from the end surface portion 123 in that the groove section 161 is open.

The groove section 161 has a planar surface portion 162 and a pair of planar surface portions 163. The surface portion 162 widens in a tangential direction of the outer circumferential surface portion 121 and an axial direction of the outer circumferential surface portion 121. The pair of surface portions 163 are widened in the axial direction of the outer circumferential surface portion 121. The pair of surface portions 163 are widened from both edge portions of the surface portion 162 in the circumferential direction of the outer circumferential surface portion 121 toward the center axis of the outer circumferential surface portion 121. The pair of surface portions 163 are widened to be separated from each other in the circumferential direction of the outer circumferential surface portion 121 as they approach the center axis of the outer circumferential surface portion 121. The surface portion 162 and the pair of planar surface portions 163 form an isosceles trapezoidal shape as a whole.

The rebound stopper 80C is also attached to the piston rod 50 in the same manner as the rebound stopper 80 and operates in the same manner as the rebound stopper 80.

Since the rebound stopper 80C has the plurality of groove sections 161, the hardness thereof is smaller than that of the rebound stopper 80, and compressive deformation in the axial direction becomes easier.

### Fifth Embodiment

Next, a fifth embodiment will be described mainly with reference to FIG. 7, focusing on differences from the first embodiment. Further, parts that are common with the first embodiment are expressed by the same names and reference signs.

In the fifth embodiment, a rebound stopper 80D, which is partially different from the rebound stopper 80, is provided in place of the rebound stopper 80. The rebound stopper 80D has a cushion member 82D, which is partially different from the cushion member 82, instead of the cushion member 82. The cushion member 82D has a second shock absorbing member 102D (second member), which is partially different from the second shock absorbing member 102, instead of the second shock absorbing member 102.

A groove section 171 is formed in an outer portion of the second shock absorbing member 102D in the radial direction. The groove section 171 extends in the axial direction of the second shock absorbing member 102D and passes through the second shock absorbing member 102D in the axial direction. The plurality of (specifically, four) groove sections 171 are formed in the second shock absorbing member 102D at equal intervals in the circumferential direction. Accordingly, the second shock absorbing member 102D has an outer circumferential surface portion 121D distinguished from the outer circumferential surface portion 121 in that the groove section 171 is open. In addition, the second shock absorbing member 102D has an end surface portion 124D distinguished from the end surface portion 124 in that the groove section 171 is open. In addition, while not shown, the second shock absorbing member 102D has an end surface portion distinguished from the end surface portion 123 in that the groove section 171 is open.

The groove section 171 has a surface portion 172 shaped like a part of a cylindrical surface, and a pair of planar surface portions 173. The surface portion 172 is disposed on the cylindrical surface coaxial with the inner circumferential surface portion 122. The pair of surface portions 173 are widened outward in the radial direction of the inner circumferential surface portion 122 from both edge portions of the surface portion 172 in the circumferential direction of the inner circumferential surface portion 122. The pair of surface portions 173 are widened in the radial direction of the inner circumferential surface portion 122 and in the axial direction of the inner circumferential surface portion 122.

The rebound stopper 80D is also attached to the piston rod 50 in the same manner as the rebound stopper 80 and operates in the same manner as the rebound stopper 80.

Since the rebound stopper 80D has the plurality of groove sections 171, the hardness thereof is smaller than that of the rebound stopper 80, and compressive deformation in the axial direction becomes easier.

Further, in the first to fifth embodiments, as the configuration in which the second shock absorbing member 102 abuts the rod guide 28 earlier than the first shock absorbing member 101, while the shaft length of the first shock absorbing member 101 is smaller than that of the second shock absorbing member 102, there is no limitation thereto. For example, the shaft length of the first shock absorbing member 101 is equal to the shaft length of the second shock absorbing member 102, and unevenness may be provided on the rod guide 28. Specifically, the outer circumferential side of the end surface 29 of the rod guide 28 is recessed in the axial direction. This also allows the second shock absorbing member 102 to abut the rod guide 28 earlier than the first shock absorbing member 101.

In addition, in the first to fifth embodiments, although the multi-cylinder type cylinder device 11 has been described as an example, the above-mentioned structure can also be applied to a single cylinder device. In the case of the single cylinder device, for example, there is a structure in which a free piston is provided at a side of the second chamber 49 opposite to the first chamber 48 and a gas chamber is provided at a side of the free piston opposite to the second chamber 49.

### REFERENCE SIGNS LIST

11 Cylinder device
17 Cylinder
24 Opening portion
28 Rod guide (blocking member)
41 Seal member (blocking member)
45 Piston
50 Piston rod
81 Stopper member
82, 82A to 82D Cushion member
101, 101A First shock absorbing member (first member)
102, 102B to 102D Second shock absorbing member (second member)

1. A cylinder device comprising:
a cylinder in which a working fluid is sealed;
a piston slidably provided in the cylinder;
a blocking member provided on the side of an opening portion of the cylinder;
a piston rod having one end side connected to the piston and the other end side inserted through the blocking member and extending to the outside of the cylinder; and
a cushion member provided between the piston and the blocking member and abutting the blocking member through extension of the piston rod,
wherein the cushion member has:
a first member; and
a second member provided inside the first member in the radial direction and having a hole passing through the second member in the axial direction or a groove partially formed in the second member so as to form a gap with respect to the piston rod or the first member, abutting the blocking member earlier than the first member and having a hardness smaller than that of the first member, and
the first member and the second member apply a force to the blocking member in parallel.

2. A cylinder device comprising:
a cylinder in which a working fluid is sealed;
a piston slidably provided in the cylinder;
a blocking member provided on the side of an opening portion of the cylinder;
a piston rod having one end side connected to the piston and the other end side inserted through the blocking member, and extending to the outside of the cylinder; and
a cushion member provided between the piston and the blocking member and abutting the blocking member through extension of the piston rod,
wherein the cushion member has:
a first member; and
a second member having a hole passing through the second member in the axial direction or a groove partially formed in the second member so as to form a gap with respect to the piston rod or the first member, and having a hardness smaller than that of the first member, and
the cylinder device has first load characteristics generated after the second member abuts the blocking member, and second load characteristics generated after the second member and the first member abut the blocking member and having a load greater than that of the first load characteristics.

3. The cylinder device according to claim 1, wherein the first member and the second member are formed in an annular shape, and the second member is disposed on an inner circumferential side of the first member.

4. The cylinder device according to claim 1, wherein the first member has a shaft length smaller than that of the second member.

5. The cylinder device according to claim 1, wherein the first member and the second member are formed integrally with each other.

6. The cylinder device according to claim 2, wherein the first member and the second member are formed in an annular shape, and the second member is disposed on an inner circumferential side of the first member.

7. The cylinder device according to claim 2, wherein the first member has a shaft length smaller than that of the second member.

8. The cylinder device according to claim 2, wherein the first member and the second member are formed integrally with each other.
